(19) United States
(12) Patent Application Publication
(10) Pub. No.: US 2006/0170830 A1
(43) Pub. Date: Aug. 3, 2006

(54) Projection-type television with connecting device

(75) Inventor: Chun-Chieh Chu, Taoyuan City (TW)

Correspondence Address: ATTN: Juan Carlos A. Marquez;REED SMITH LLP, Suite 1400, 3110 Fairview Park Drive, Falls Church, VA, 22042, US

(73) Assignee: BenQ Corporation

(21) Appl. No.: 11/340,508

(22) Filed: Jan. 27, 2006

(30) Foreign Application Priority Data
Jan. 28, 2005 (TW) 94102613

(51) Int. Cl. H04N 5/64

(52) U.S. Cl. 348/789

(57) ABSTRACT

A projection-type television is provided. The projection-type television includes a housing, a frame device, a projection screen and a connecting device. The connecting device cooperates with the frame device to fix the projector screen. The projector screen at least includes a first fringe portion and a second fringe portion, and the frame device at least includes a first frame component, a second frame component and a connector. The first fringe portion is disposed in a first slot formed in the first frame component. The second fringe portion is disposed in a second slot formed in the second frame component. The connector connects the first frame component with the second frame component. The frame device facilitates fixing the projection screen, and then the projection screen can be disposed at desirable positions according to a user's need.

### FIELD OF THE INVENTION

This invention relates to a projection-type television. The projection-type television includes a housing, a frame device, a projection screen and a connecting device. The connecting device and the frame device collectively hold and fix the projection screen.

### BACKGROUND OF THE INVENTION

With the vital development in optic-electronic industry, displaying images by projection way becomes more popular. A proper projection screen influences the quality of image display.

Many designs of the projection screens adopt soft materials for storage convenience. Thus an additional auxiliary frame device is needed to keep the projection screen being flat, for better quality of the image displayed by the projection screen.

In prior art, the frame device includes several battens fixed outside the projection screen. Those battens then connect and are fixed with each other. The disadvantages of this method are difficulty of assembling and cost a lot of time during assembling.

### SUMMARY OF THE INVENTION

A projection-type television is provided in the present invention. The projection-type television includes a housing, a frame device, a projection screen and a connecting device. The connecting device and the frame device collectively fix the projection screen. By the frame device, the projection screen can be disposed in the projection-type television conveniently.

The frame device of the present invention includes a first frame component, a second frame component, a third frame component, a fourth frame component and four connectors. The first frame component, the second frame component, the third frame component, and the fourth frame component are used to accommodate the projection screen, and the four connectors are used to connected the mentioned frame components respectively.

A method for fix a projection screen by a frame device is also provided. The method includes: disposing the projection screen into the slots formed in the frame device; connecting each frame component by connectors; finally, keeping a relative distance between the projection screen and the frame device constant.

### BRIEF DESCRIPTION OF THE DRAWINGS

FIG. 1 is a schematic view illustrating a frame device of the present invention.

FIG. 2(a) is a side view illustrating an embodiment of a frame component of the present invention.

FIG. 2(b) is a schematic view illustrating an embodiment of a connector of the present invention.

FIG. 2(c) is a side view illustrating another embodiment of a frame component of the present invention.

FIG. 3(a) is a side view illustrating an embodiment of a connector of the present invention.

FIG. 3(b) is a side view illustrating another embodiment of a connector of the present invention.

FIG. 4 is a schematic view illustrating assembling of the frame device and the housing of the present invention.

FIG. 5 is a schematic view illustrating how the frame device connecting with the projection screen.

FIG. 6 is a schematic view illustrating the method of the present invention.

FIG. 7(a) is a schematic view illustrating the method of the present invention.

FIG. 7(b) is a schematic view illustrating the method of the present invention.

FIG. 7(c) is a schematic view illustrating the method of the present invention.

### DETAILED DESCRIPTION OF THE INVENTION

The present invention relates to a projection-type television 400 and a method for fixing a projection screen conveniently.

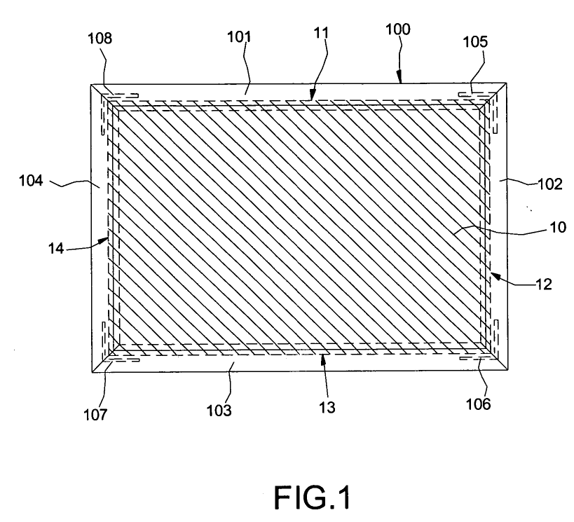

FIG. 1 illustrates a frame device of the present invention. As shown in FIG. 1, the frame device 100 is used for fixing the projection screen. The projection screen 10 includes a first fringe portion 11, a second fringe portion 12, a third fringe portion 13 and a fourth fringe portion 14. The projection screen 10 can be made of softer acrylic, fabric or other materials of similar properties. The frame device 100 includes a first frame component 101, a second frame component 102, a third frame component 103 and a fourth frame component 104. The frame device 100 also includes a first connector 105, a second connector 106, a third connector 107 and a fourth connector 108. The first fringe portion 11, the second fringe portion 12, the third fringe portion 13 and the fourth fringe portion 14 of the frame device 100 are respectively disposed into the slots formed in the first frame component 101, the second frame component 102, the third frame component 103 and the fourth frame component 104, respectively. Details please refer to description set forth below.

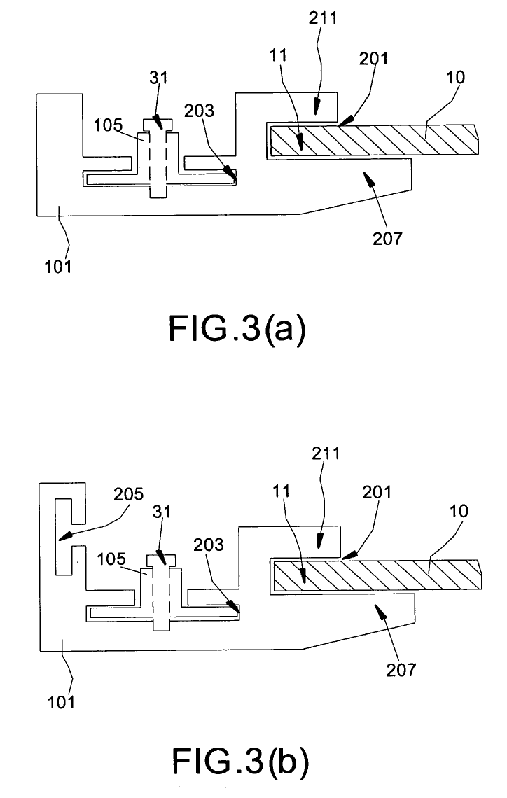

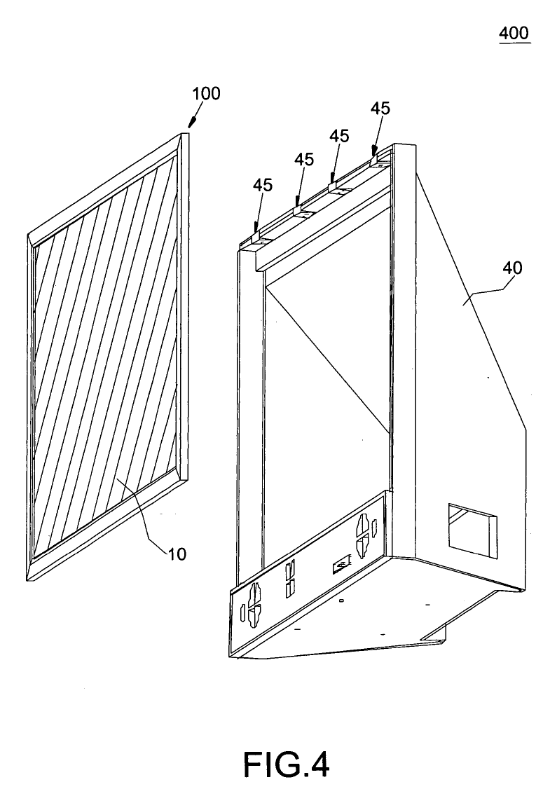

The first connector 105, the second connector 106, the third connector 107 and the fourth connector 108 are used to connect the first frame component 101, the second frame component 102, the third frame component 103 and the fourth frame component 104, respectively. Details please refer to description of FIG. 3(a) set forth below. After the projection screen 10 is disposed in a desirable position, the frame device 100 keeps the frame components 101, 102, 103 and 104 immobile to each other by connectors 105, 106, 107 and 108. At this time, the projection screen 10 is fixed and kept flat for image projecting.

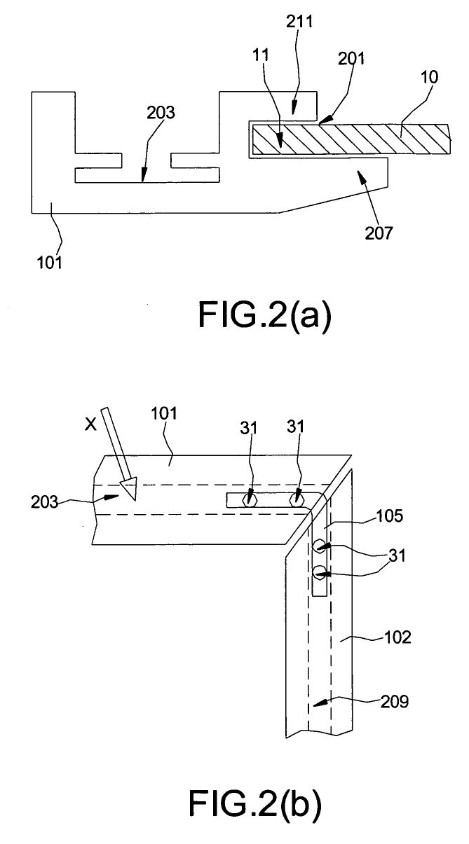

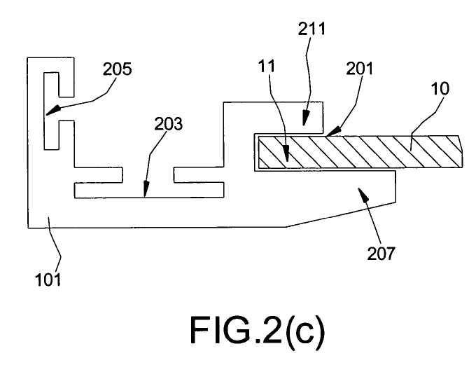

FIG. 2(a) is a side view illustrating an embodiment of a frame component of the present invention. In FIG. 2(a), details of the frame components 101, 102, 103 and 104 are disclosed, as well as how the projection screen 10 is disposed inside the frame components 101, 102, 103 and 104. In FIG. 2(a), the first frame component 101 is chosen as an exemplary illustration, and actually, other frame components also can be embodied as shown in FIG. 2(a). The first frame component 101 defines a first receiving slot 201 and a first slot 203. A first support stage 207 is disposed near the first receiving slot 201. The first frame component 101 includes a first protrusion 211, opposite to the first support stage 207 and near the first receiving slot 201. The first support stage 207 extends to a geometric center of the frame device 100 at a length greater than a length of the first protrusion 211. The first receiving slot 201 is used to accommodate the projection screen 10 (Referring to the first fringe portion 11 of the projection screen 10 in FIG. 1). The first frame component 101 can clip or adhere to the first fringe portion 11 of the projection screen 10. The first support stage 207 near the first receiving slot 201 is used to facilitate the projection screen 10 (especially the soft one) being disposed in the first receiving slot 201, by allowing the first fringe portion 11 to slide into the first receiving slot 201 along the first support stage 207. Details please refer to the description of the embodiment of the fixing method in the present invention set forth below.

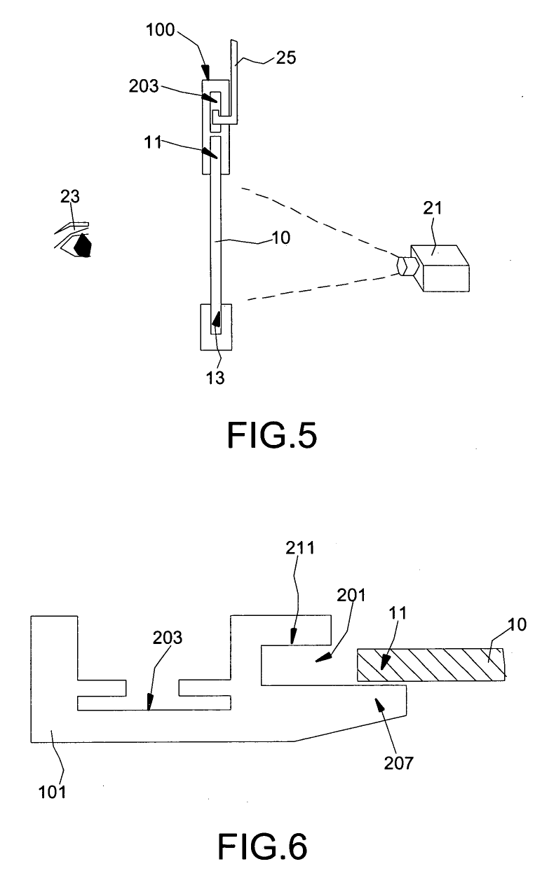

FIG. 2(b) is a schematic view illustrating an embodiment of a connector of the present invention. As shown in FIG. 2(b), the first connector 105 respectively engages the first frame component 101 and the second frame component 102 by bolts 31 (The number of the bolts 31 is determined according to a user's need, not limited as shown in FIG. 2(b)). Since the first connector 105 only occupies a part of the first slot 203, other parts of the first slot 203 can be used to connect with the connecting device. Please refer to the exemplary position marked by arrow X in FIG. 2(b), and also refer to further description of the connecting method in FIG. 5.

FIG. 2(c) is a schematic view illustrating another embodiment of the connector of the present invention. Different from the embodiment described in FIG. 2(a), the frame component in FIG. 2(c) further includes an auxiliary slot 205. The auxiliary slot 205 can enhance the stability and safety of the connection between the frame device 100 and the connecting device 25, especially when the frame components are of greater weights. The auxiliary slot 205 also provides similar function as the first slot 203 (Part of the slot is for engaging the frame components, and other parts of the slot are for connecting with the connecting device), so that it provides ample strength for connecting and engaging to secure stability and safety.

FIG. 3(a) is a side view illustrating an embodiment of a connector of the present invention. As shown in FIG. 2(a), the first frame component 101 includes a first slot 203. The first slot 203 is used for the first connector 105 connecting the frame components 101 and 102. As shown in FIG. 3(a), the first connector 105 fixes the first frame component 101 and the second frame component 102 respectively by bolts 31 (The number of the bolts 31 is determined according to a user's need). Referring to FIG. 3(a), the first connector 105 is disposed in the first slot 203, and the bolts 31 penetrate the first connector 105 to connect the first frame component 101 with the first connector 105. In other embodiments, methods providing similar connecting functions can be adopted, for instance, a latching method. Referring to FIGS. 2(a) and 3(a), it can be recognized that, the first slot 203 is mainly used for accommodating the first connector 105 (as described in FIGS. 2(b) and 2(c), the first slot can also be used for connecting the connecting device 25), and the second slot 29 of the second frame component 102 is also used to accommodate the first connector 105 for fixing the frame components 101 and 102. Similarly, other connectors 106, 107 and 180 also include similar functions.

FIG. 3(b) is a side view illustrating another embodiment of a connector of the present invention. Different from the embodiment disclosed in FIG. 3(a), the embodiment in FIG. 3(b) further includes an auxiliary slot 205. The auxiliary slot 205 can enhance the stability and safety of the connection between the frame device 100 and the connecting device 25, especially when the frame components are of greater weights. Please refer to detail description for FIG. 2(c).

FIG. 4 is a schematic view illustrating assembling of the frame device 100 and the housing 40 of the present invention. The projection-type television 400 includes a housing 40 and several connecting device 45. After the frame device 100 completely fixing the projection screen 10, the frame device 100 and the projection screen 10 are assembled with the housing 40 for the projection-type television 400 to display images. In FIG. 4, the frame device 100 and the projection screen 10 are hanged on the connecting device 45. Several fixing methods can be applied to fix the frame device 100 and the housing 40, for example, using screws and nuts or latches, to keep the stability of connection.

FIG. 5 is a schematic view illustrating how the frame device 100 connecting with the projection screen 10. After the frame device 100 completely fixing the projection screen 10, the frame device 100 and the projection screen 10 can be hanged on a connecting device 25. In this embodiment, a projector 21 can project images on the projection screen 10, and a user can see the images formed on the projection screen 10. As shown in FIG. 5, the first slot 203 of the frame device 100 is used for accommodate a protrusion of the connecting device 25, for facilitating fixing the frame device 100 and the connecting device 25. The configuration of the projector 21 and a user 23 described in FIG. 5 is exemplary, however, in other embodiments, configurations without departing the scope of the present invention are also acceptable.

The present invention provides a method for fixing a projection-type television by a frame device 100. The method includes at least steps of: connecting the frame components respectively by connectors (Although only the first connector 105 is disclosed in FIG. 3(a), each frame component has its own corresponding connector); disposing the projection screen 10 on the support stages of the frame device respectively (Although only the first support stage 207 is disclosed in FIG. 2(a), each frame component has its own corresponding support stage); disposing the fringe portions 11, 12, 13 and 14 into the corresponding slots, to keep the relative position between of the projection screen 10 and the frame device 100 unchanged.

FIG. 6 is a schematic view illustrating the method of the present invention. FIG. 6 illustrates how to dispose the projection screen 10. First, the first fringe 11 is disposed on the first support stage 207. Due to the first support stage 207 extends to a geometric center of the frame device 100 at a length greater than a length of the first protrusion 211, a user can easily disposes the projection screen 10 on the first support stage 207. Afterward, pushing the frame components 101, 102, 103 and 104 to the geometric center of the frame device 100 allows the fringe portions 11, 12, 13, 14 disposed in each slots respectively (As shown in FIG. 2(a)). Then fixing the frame components respectively (As shown in FIG. 3(a).) is the last step of the fixing method.

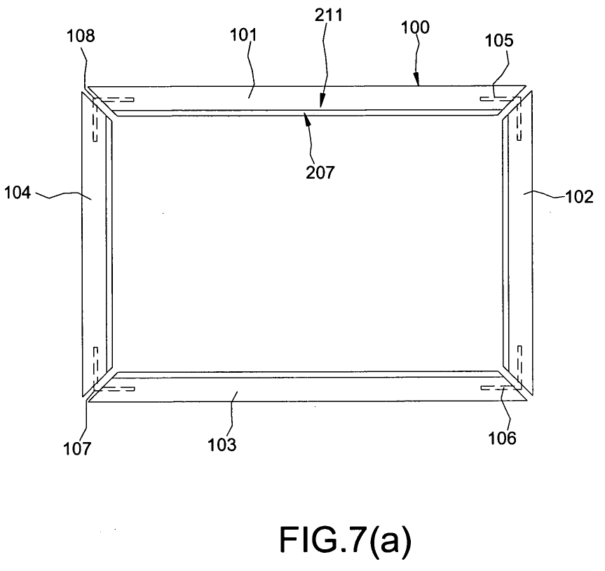

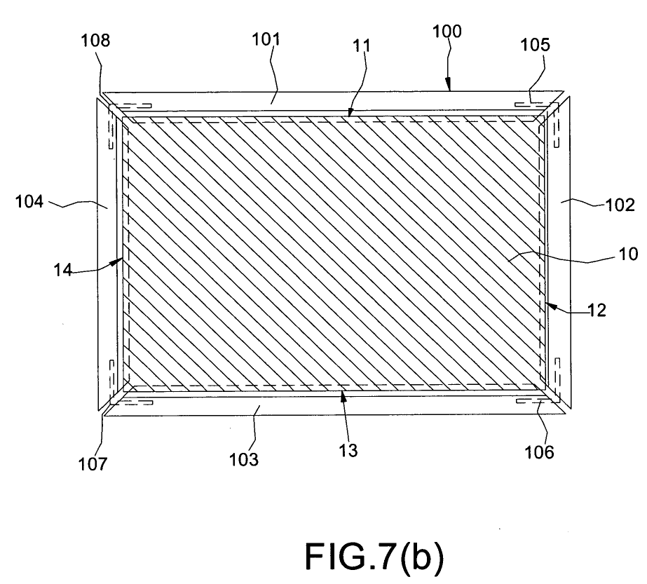

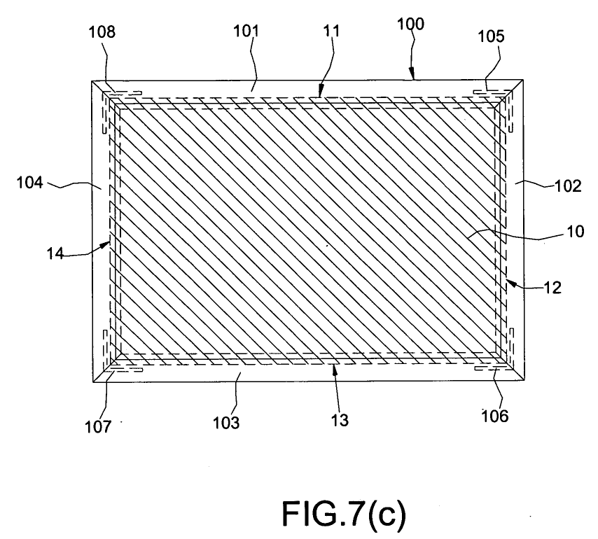

FIG. 7(a), 7(b) and (c) are a schematic views illustrating the method of the present invention. In FIG. 7(a), the frame components 101, 102, 103 and 104 are connected with each other by connectors 105, 106, 107 and 108 (but not yet fixed). At this time, each of the frame components 101, 102, 103 and 104 keeps a distance from the adjacent frame components, and the peripheral length of the protrusions (Including the first support stage 211 and other non-illustrated support stages, the second support stage, the third support stage and the fourth support stage) of each frame components is smaller than the peripheral length of the projection screen 10. In FIG. 7(b), because the first support stage 207 extends to a geometric center of the frame device 100 at a length greater than a length of the first protrusion 211, a user can easily disposes the projection screen 10 on the first support stages (Please also refer to FIG. 6). Finally, as shown in FIG. 7 (c), the frame components 101, 102, 103 and 104 are pushed closer to each other by guidance of the connecters 105, 106, 107 and 108, until the distances between two frame components are approximately zero. Then the bolts 31 are used to fix the frame components 101, 102, 103 and 104 and the connectors 105, 106, 107 and 108. After applying the fixing method described above, the projection screen 10 is fixed by the frame device 100, and can be used for projecting images thereon.

In other embodiment, a user may only have to keep a first predetermined distance between the first and the second frame components, and a third predetermined distance between the third and the fourth frame components in the step of connecting the connectors with the frame components, since keeping two predetermined distance is sufficient to make sure the following assembling step correctly done. For more accurate assembling, users can choose to keep three or four (e.g. the embodiment described in FIGS. 7(a), 7(b) and 7(c)) predetermined distance in the step of connecting the connectors with the frame components.

While the invention has been described in connection with what is presently considered to be the most practical and preferred embodiments, it is to be understood that the invention is not to be limited to these embodiments. The invention is intended to cover various modifications and equivalent arrangements within the spirit and scope of the appended claims.

1. A projection-type television, comprising:
a housing;
a projection screen, including a first fringe portion, a second fringe portion, a third fringe portion and a fourth fringe portion;
a frame device, including:
a first frame component including a first support stage and a first protrusion, the first support stage and the first protrusion extending substantially in parallel, and forming a first receiving slot between the first support stage and the first protrusion, for facilitating the first fringe portion to be disposed into the first receiving slot
a second frame component including a second support stage and a second protrusion, the second support stage and the second protrusion extending substantially in parallel, and forming a second receiving slot between the second support stage and the second protrusion, for facilitating the second fringe portion to be disposed into the second receiving slot;
a third frame component including a third support stage and a third protrusion, the third support stage and the third protrusion extending substantially in parallel, and forming a third receiving slot between the third support stage and the third protrusion, for facilitating the third fringe portion to be disposed into the third receiving slot;
a fourth frame component including a fourth support stage and a fourth protrusion, the fourth support stage and the fourth protrusion extending substantially in parallel, and forming a fourth receiving slot between the fourth support stage and the fourth protrusion, for facilitating the fourth fringe portion to be disposed into the fourth receiving slot;
a first connector connected with the first frame component and the second frame component respectively;
a second connector connected with the second frame component and the third frame component respectively;
a third connector connected with the third frame component and the fourth frame component respectively; and
a fourth connector connected with the fourth frame component and the first frame component respectively; and
a connecting device for attaching the frame device to the housing;
wherein, the first support stage extends to a geometric center of the frame device at a length greater than a length of the first protrusion; the third support stage extends to the geometric center of the frame device at a length greater than a length of the third protrusion.

2. The projection television according to claim 1, wherein the second stage extends to the geometric center of the frame device at a length greater than a length of the second protrusion.

3. The projection television according to claim 1, wherein the fourth stage extends to the geometric center of the frame device at a length greater than a length of the fourth protrusion.

4. The projection television according to claim 1, wherein the first frame component includes an auxiliary slot for facilitating the projection screen to be disposed at a specific position.

5. The projection television according to claim 1, wherein the first frame component defines a first slot, the second frame component defines a second slot, the third frame component defines a third slot, and the fourth frame defines a fourth slot; the first connector engages with the first slot and the second slot respectively, the second connector engages with the second slot and the third slot respectively, the third connector engages with the third slot and the fourth slot respectively, and the fourth connector engages with the fourth slot and the first slot respectively.

6. A method for fixing a projection screen of a projection-type television by a frame device, the frame device including a first frame component, a second frame component, a third frame component, a fourth frame component, a first connector, a second connector, a third connector and a fourth connector, the first frame component including a first support stage and a first protrusion, the first support stage and the first protrusion extending substantially in parallel and forming a first receiving slot between the first support stage and the first protrusion, the second frame component including a second support stage and a second protrusion, the second support stage and the second protrusion extending substantially in parallel, and forming a second receiving slot between the second support stage and the second protrusion, the third frame component including a third support stage and a third protrusion, the third support stage and the third protrusion extending substantially in parallel, and forming a third receiving slot between the third support stage and the third protrusion, the fourth frame component including a fourth support stage and a fourth protrusion, the fourth support stage and the fourth protrusion extending substantially in parallel, and forming a fourth receiving slot between the fourth support stage and the fourth protrusion, the projection screen including a first fringe portion, a second fringe portion, a third fringe portion and a fourth fringe portion, the method comprising:
connecting the first connector with the first frame component and the second frame component respectively, and keeping a first predetermined distance between the first frame component and the second frame component, connecting the second connector with the second frame component and the third frame component respectively, connecting the third connector with the third frame component and the fourth frame component respectively, and keeping a third predetermined distance between the third frame component and the fourth frame component, connecting the fourth connector with the fourth frame component and the first frame component respectively, wherein a peripheral length defined by the first protrusion, the second protrusion, the third protrusion and the fourth protrusion being greater than a peripheral length of the projection screen, and a peripheral length defined by the first support stage, the second support stage, the third support stage and the fourth support stage being smaller than the peripheral length of the projection screen;
disposing the first fringe portion, the second fringe portion, the third fringe portion and the fourth fringe portion, through a peripheral defined by the first protrusion, the second protrusion, the third protrusion and the fourth protrusion, on the first support stage, the second support stage, the third support stage, and the fourth support stage respectively;
moving the second frame component and the third frame component closer to one another by guidance of the first connector, the second connector and the third connector respectively, such that the first predetermined distance, a second predetermined distance and a third predetermined distance being substantially close to zero, and keeping a relative position between the frame device and the first fringe portion, the second fringe portion, the third fringe portion and the fourth fringe portion unchanged.

7. The method according to claim 4, wherein the first frame includes an auxiliary slot for facilitating the projection screen to be disposed at a specific position.

8. The method according to claim 4, wherein the first frame component defines a first slot, the second frame component defines a second slot, the third frame component defines a third slot, and the fourth frame component defines a fourth slot; the first connector engages with the first slot and the second slot respectively, the second connector engages with the second slot and the third slot respectively, the third connector engages with the third slot and the fourth slot respectively, and the fourth connector engages with the fourth slot and the first slot respectively.

9. The method according to claim 6, in the step of connecting the second connector with the second frame component and the third frame component, and the step of connecting the fourth connector with the fourth frame component and the first frame component, further comprising keeping a second predetermined distance between the second frame component and the third frame component, and keeping a fourth predetermined distance between the fourth frame component and the first frame component respectively.

10. The method according to claim 6, wherein the fourth connector guides the fourth frame component to be closer to the first frame component.
